(19) United States
(12) Patent Application Publication
(10) Pub. No.: US 2008/0172487 A1
(43) Pub. Date: Jul. 17, 2008

(54) Systems and methods for providing targeted marketing

(75) Inventors: Jeffrey Brunet, Richmond Hill (CA); Ian Collins, Markham (CA); Yousuf Chowdhary, Maple (CA)

Correspondence Address: CARR & FERRELL LLP, 2200 GENG ROAD, PALO ALTO, CA, 94303, US

(73) Assignee: Storage Appliance Corporation

(21) Appl. No.: 12/006,606

(22) Filed: Jan. 3, 2008

Related U.S. Application Data
(60) Provisional application No. 60/878,207, filed on Jan. 3, 2007.

(51) Int. Cl. G06F 15/16; G06F 17/30

(52) U.S. Cl. 709/224; 707/100; 707/E17.005

(57) ABSTRACT

Systems and methods are provided for automatically collecting information from a computer system and sending the collected information across a network to a centralized system. The information can include configuration information that describes the configuration of the computing system, such as the installed software, internal hardware, and attached peripherals. The centralized system is configured to return targeted marketing based on the collected information. Providing the centralized system with automatically collected configuration and other information allows for better targeted marketing.

### CROSS-REFERENCE TO RELATED APPLICATIONS

This application claims the benefit of U.S. Provisional Patent Application No. 60/878,207 filed on Jan. 3, 2007 and entitled “Method and a System for Information Extraction from a Data Source and Using the Same for Dynamic Advertising.” This application is related to U.S. patent application Ser. No. 11/506,386 filed on Aug. 18, 2006 and entitled “Data Backup Devices and Methods for Backing up Data” which is a divisional application of U.S. patent application Ser. No. 11/492,380 filed on Jul. 24, 2006 and entitled “Emulation Component for Data Backup Applications.” This application is also related to U.S. patent application Ser. No. 11/546,176 filed on Oct. 10, 2006 and entitled “Optical Disc Initiated Data Backup.” This application is also related to U.S. patent application Ser. No. 11/601,040 filed on Nov. 16, 2006 and entitled “Methods for Selectively Copying Data Files to Networked Storage and Devices for Initiating the Same” which is also a Continuation-in-Part of U.S. patent application Ser. Nos. 11/506,386 and 11/546,176. Each of the aforementioned applications is incorporated herein by reference.

### BACKGROUND OF THE INVENTION

1. Field of the Invention

The present invention relates generally to the field of marketing and more particularly to targeted marketing based on collected information.

2. Description of the Prior Art

Targeted marketing seeks to selectively direct advertising towards potential purchasers. Accordingly, targeted marketing relies on information about potential purchasers in order to make appropriate selections. To the extent that the information relied upon is based on assumptions or is inaccurate or incomplete, targeted marketing becomes less effective.

As one example, many manufacturers collect information for targeted marketing through product registration. Traditionally, product registration is conducted by filling out a paper registration form which is mailed back to the manufacturer. One problem with the traditional method is that many customers find the entire process too bothersome. Customers often have to locate lengthy serial numbers, and some times other numbers, on the purchased product that are frequently placed in inconspicuous locations. Customers then have to faithfully transcribe these serial numbers onto the paper form. Many times the form provides a line that is too short for the entire serial number, or provides a series of tiny boxes that are difficult to write within. In many instances customers have difficulty determining the requested numbers from a myriad of information on the purchased product. Additionally, these forms are easily lost with the packaging, or put aside and forgotten. For these and other reasons, the compliance rate for product registration through paper forms is generally poor.

While the traditional form of product registration remains common, on-line product registration is becoming increasingly popular. On-line product registration does not alleviate many of the problems noted above, however. For example, customers still have to locate and transcribe numbers. Directions regarding on-line product registration are often distributed in paper form with the product packaging and are still subject to being lost or misplaced. Additionally, errors are common with both methods, for example, inadvertent errors due to the manual transcription step, and deliberate errors due to the purposeful inclusion of fake information. Accordingly, compliance with on-line registration is poor, and the accuracy of the gathered data is lacking. Thus, both paper and on-line product registration provides information for targeted marketing that is of dubious value.

Accordingly, what is needed are systems and methods for targeted marketing that employ more trustworthy information about the targeted consumers.

### SUMMARY

An exemplary method of the invention comprises automatically searching an end user computing system for configuration information of the end user computing system, sending the configuration information across a network to a centralized system, and receiving targeted marketing from the centralized system across the network, the targeted marketing based on the configuration information. In various embodiments, automatically searching the end user computing system can include searching operating system files and searching an initialization file. In some embodiments, the targeted marketing comprises an offer of goods or services.

The exemplary method can further comprise receiving user consent to receive the targeted marketing. Additionally, the exemplary method can further comprise displaying the targeted marketing on the end user computing system. In some embodiments the method further comprises searching the end user computing system for a user setting and sending the user setting across the network to the centralized system. In these embodiments the method further comprises receiving targeted marketing from the centralized system across the network, where the targeted marketing is based on the user setting.

Another exemplary method of the invention comprises receiving, at a centralized system, configuration information of an end user computing system, the receiving occurring across a network from the end user computing system. The method further comprises determining targeted marketing based on the configuration information, and sending the targeted marketing from the centralized system across the network to the end user computing system. In some embodiments, the method further comprises storing the configuration information in a database, and in some of these embodiments the database associates the configuration information with a unique ID for the end user computing system.

The present invention also provides a computer readable medium having stored thereupon computing instructions. The computing instructions comprise a code segment to automatically search an end user computing system for configuration information of the end user computing system, a code segment to send the configuration information across a network to a centralized system, and a code segment to receive targeted marketing from the centralized system across the network, the targeted marketing based on the configuration information. In some embodiments the computer readable medium further comprises a code segment to receive user consent to receive the targeted marketing. The computer readable medium can also comprise a code segment to display the targeted marketing on the end user computing system.

### BRIEF DESCRIPTION OF DRAWINGS

FIG. 1 shows a schematic representation of an end user computing system connected across a network to a centralized system according to an embodiment of the present invention.

FIG. 2 shows a flowchart representation of a method for receiving targeted marketing according to an embodiment of the present invention.

FIG. 3 shows a flowchart representation of a method for providing targeted marketing according to an embodiment of the present invention.

FIG. 4 shows a schematic representation of a backup device connected to an end user computing system according to an embodiment of the present invention.

FIG. 5 shows a schematic representation of a backup device according to another embodiment of the present invention.

FIG. 6 shows an end user computing system with an internal optical drive and an attached external optical drive for receiving the backup device of FIG. 5 according to an embodiment of the present invention.

FIG. 7 shows a schematic representation of a backup device according to another embodiment of the present invention.

### DETAILED DESCRIPTION OF THE INVENTION

The present invention is directed to systems and methods for collecting information, such as product registration information, and for using that information to provide targeted marketing. Methods of the present invention collect information by automatically searching an end user computing system for the information. The information can be, for example, information that manufacturers typically collect from purchasers that register their products, such as name, street address, e-mail address, product model and serial number, and so forth. In various embodiments, at least some of the information automatically gathered from the end user computing system pertains to how the end user computing system is particularly configured, such as the installed software and hardware. The information is provided to a centralized system which can store the information for product registration purposes and can additionally use the information to generate targeted marketing which is sent to the end user computing system.

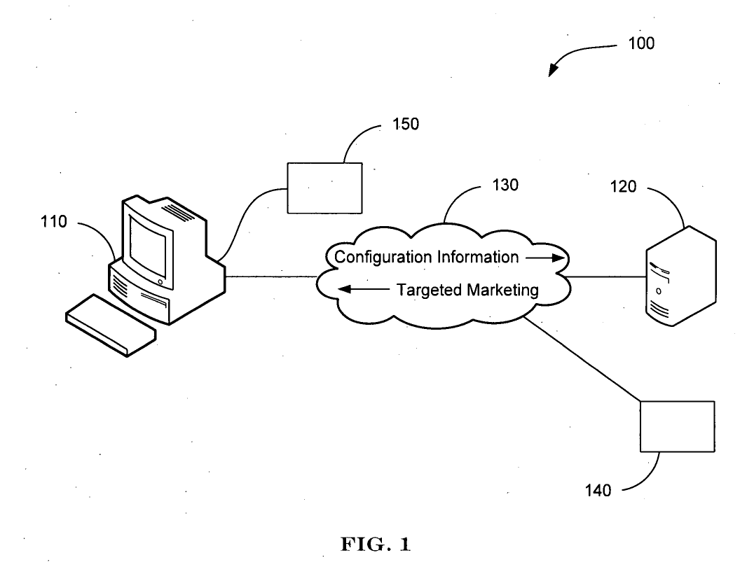

FIG. 1 illustrates an exemplary system 100 of the present invention. The system 100 comprises an end user computing system 110 and a centralized system 120. The end user computing system 110 can be any computing system comprising a processor and memory, such as a personal computer (PC). The end user computing system 110 has a particular configuration, and information that specifies the particular configuration of the end user computing system 110 is referred to herein as configuration information. Configuration information can include, for instance, the names of installed software applications and their versions, the types of installed hardware and their model and serial numbers, time zone and default language settings, information about the central processing unit (CPU), information about network settings, etc. It will be appreciated that installed hardware can include internal hardware such as network and graphics cards, as well as attached peripherals such as printers, scanners, monitors, speakers, keyboards and mice, music players (e.g., iPods, MP3 players, etc.), cell phones, video and still cameras, Personal Digital Assistants (PDAs), DVD burners, video game consoles, external storage devices, and so forth.

The centralized system 120 is configured to generate targeted marketing based on the configuration information. The centralized system 120 is depicted as a server in FIG. 1, however, the centralized system 120 can comprise, for example, a system of multiple servers, computers, and/or databases. In some embodiments, the centralized system 120 is in further communication through a network 130 such as the Internet with one or more 3^{rd} party systems 140. A 3^{rd} party system 140 can be, for example, a source of content that the centralized system 120 employs to generate the targeted marketing. As described further below, the 3^{rd} party system 140 can also be a source of additional information that the centralized system 120 can use, along with the configuration information, to generate targeted marketing.

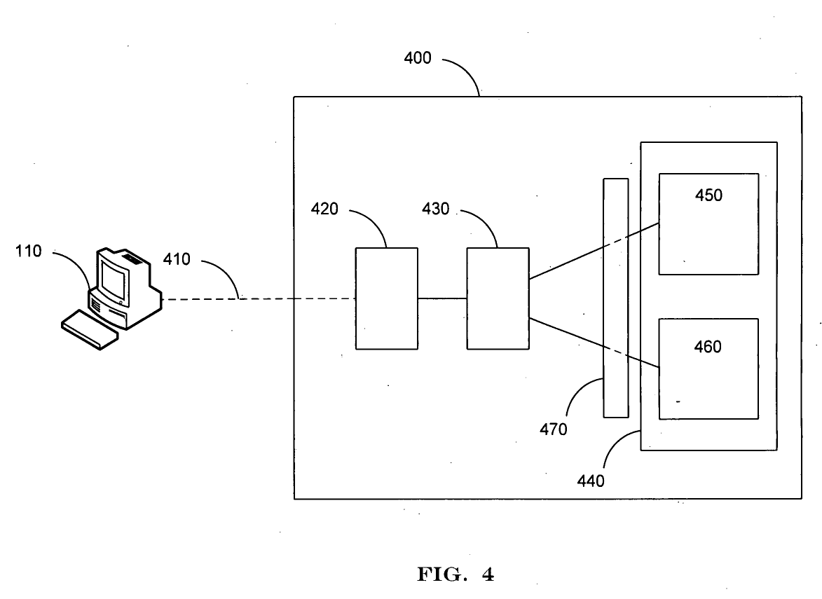

The end user computing system 110 and the centralized system 120 can be connected across the network 130, or another network. The connection between the end user computing system 110 and the centralized system 120 can be established, in some instances, in response to an event such as the connection or installation of a new hardware 150. One particular example of such hardware 150 is a backup device such as described below with respect to FIGS. 4-7. Once connected, configuration information is transmitted from the end user computing system 110 to the centralized system 120, and the centralized system 120 returns targeted marketing based on the configuration information to the end user computing system 110.

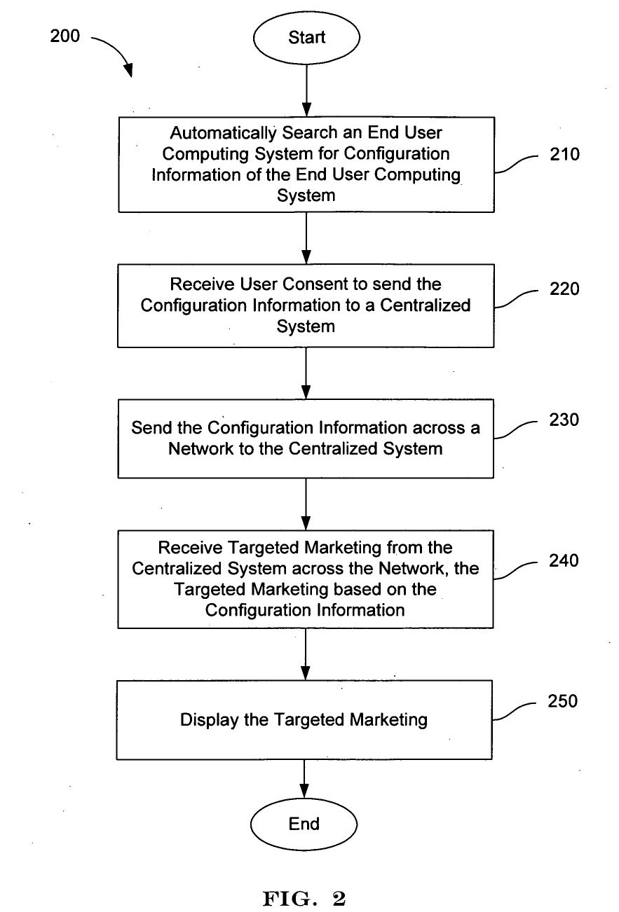

FIG. 2 illustrates an exemplary method 200 of the invention. The method 200 comprises automatically searching 210 an end user computing system for configuration information of the end user computing system. The method 200 optionally comprises receiving 220 a user consent to send the configuration information to a centralized system. Whether or not an embodiment comprises receiving 220 the user consent, the method 200 further comprises sending 230 the configuration information across a network to the centralized system. Additionally, the method 200 comprises receiving 240 targeted marketing from the centralized system across the network, where the targeted marketing is based on the configuration information. Embodiments of the method 200 can optionally also comprise displaying 250 the targeted marketing.

The method 200 comprises automatically searching 210 the end user computing system for configuration information thereof. In some embodiments, automatically searching 210 the end user computing system is performed by an application that is distributed with new hardware or software. For example, when new hardware 150 (FIG. 1) is first connected to the end user computing system 110 (FIG. 1), an application distributed with the new hardware 150 can be run to complete the product registration. Examples of applications that can be distributed with new hardware include the backup applications described in U.S. patent application Ser. Nos. 11/506,386, 11/492,380, 11/546,176, and 11/601,040 noted previously. In the case of new hardware, the application can be distributed on a compact disc (CD) with the new hardware. In other instances the application can be stored in non-volatile memory of the new hardware itself. In still other instances the application can be downloaded from a website as part of the hardware installation. It will be appreciated that certain operating systems are able to launch such applications automatically. In some embodiments, automatically searching 210 the end user computing system is performed in response to a trigger, for example, at a particular time of day or after some predefined time interval has elapsed.

Automatically searching 210 the end user computing system for configuration information can be either comprehensive or limited. For example, where new hardware comprises a monitor, the sought after configuration information might be limited to installed graphics cards. Where new software comprises as an operating system, on the other hand, configuration information pertaining to all installed hardware and software can be sought.

Automatically searching 210 the end user computing system for configuration information can include searching an initialization file (.ini file) of an installed application for configuration information such as the version number and settings of the application. Automatically searching 210 the end user computing system can also include, in some embodiments, automatically searching operating system files such as registry and startup files. For instance, configuration information for an installed printer can be found in registry keys such as HKEY_LOCAL_MACHINE\SYSTEM\CurrentControlSet\Control\Print\Environments\Windows NT x86\Drivers\Version-3\Printer Name and HKEY_LOCAL_MACHINE\SYSTEM\CurrentControlSet\Control\Print\Printers\Printer Name. Configuration information specifying the DVD region setting for the end user computing system can be found in HKEY_LOCAL_MACHINE\SYSTEM\CurrentControlSet\ENUM\IDE\ . . . \DeviceParameters\DefaultDVDRegion. Configuration information specifying the time zone setting for the end user computing system can be found in HKEY_LOCAL_MACHINE\SYSTEM\CurrentControlSet\Control\TimeZoneInformation\DaylightName or StandardName.

As noted above, the method 200 can optionally comprise receiving 220 a user consent to send the configuration information to a centralized system. Such consent can be received 220 from the user through a display on a graphical user interface (GUI) of the end user computing system, for example. While receiving 220 the user consent is shown in FIG. 2 as following automatically searching 210 the end user computing system, it should be appreciated that receiving 220 the user consent can precede automatically searching 210 the end user computing system. Receiving 220 the user consent, in some embodiments, also comprises receiving user consent to receive targeted marketing. For instance, the user may be asked to check a box that says “By checking this box I agree to receive targeted marketing from XYZ Corporation. I understand that information about my computer will be sent to XYZ Corporation for this purpose.”

In some instances, receiving 220 the user consent includes displaying to the user the configuration information that was found by automatically searching 210 the end user computing system. In this way the user knows before granting consent what information will be sent. For example, in the case of product registration, a product registration form can be displayed such that the fields of the form are filled with the configuration information found by automatically searching 210 the end user computing system. The user then has the option to modify the information within any of the fields, fill in any blank fields, as well as print or save the completed form.

The method 200 further comprises sending 230 the configuration information across the network to the centralized system. Sending 230 the configuration information can comprise, in some instances, establishing a connection between the end user computing system and the centralized system by specifying a Uniform Resource Locator (URL) for the centralized system. The configuration information can be sent 230 to the centralized system in increments, in some embodiments. Sending 230 the configuration information can also be performed in response to a trigger. Although FIG. 2 shows sending 230 the configuration information following automatically searching 210 the end user computing system, it will be understood that sending 230 the configuration information can begin before automatically searching 210 the end user computing system has finished. Once the configuration information has been sent, the method 200 can further comprise, in some embodiments, noting that this has occurred. This can be achieved, for example, by setting a flag or placing a marker that indicates the configuration information has already been sent.

Method 200 also comprises receiving 240 targeted marketing from the centralized system across the network, where the targeted marketing is based on the configuration information. The method 200 can optionally also comprise displaying 250 the received targeted marketing on the end user computing system. The targeted marketing can be received 240 and displayed 250 within an e-mail or a browser pop-up window, for example. The method 200 can also optionally comprise storing the received targeted marketing on the end user computing system, for example, in a folder.

The targeted marketing can comprise, for example, an offer of goods or services. Where the configuration information specifies a particular model of printer, for instance, the targeted marketing can comprise an offer for toner cartridges for that model. Similarly, the targeted marketing can comprise an offer of a service contract for that model. The targeted marketing can also comprise information that might be of interest to the user such as user forums, blogs, events, and the like.

In further embodiments, the method 200 can additionally comprise searching the end user computing system for a user setting in addition to searching 210 the end user computing system for configuration information. User settings encompass those user-customizations and personalizations saved by an application or an operating system, as discussed in U.S. patent application Ser. No. 11/998,096 filed on Nov. 27, 2007 and entitled “Systems and Methods for Backing Up User Settings” which is incorporated herein by reference. These embodiments additionally comprise sending the user setting across the network to the centralized system, and receiving targeted marketing from the centralized system across the network, where the targeted marketing is based on the configuration information and/or the user setting.

In still other embodiments, the method 200 can additionally comprise monitoring the end user computing system. For example, methods such as click monitoring can be employed to track user interactions with the targeted marketing. As another example, background monitoring can be employed to track changes to the configuration of the end user computing system. Information derived from such monitoring can also be sent to the centralized system to be used to generate the targeted marketing.

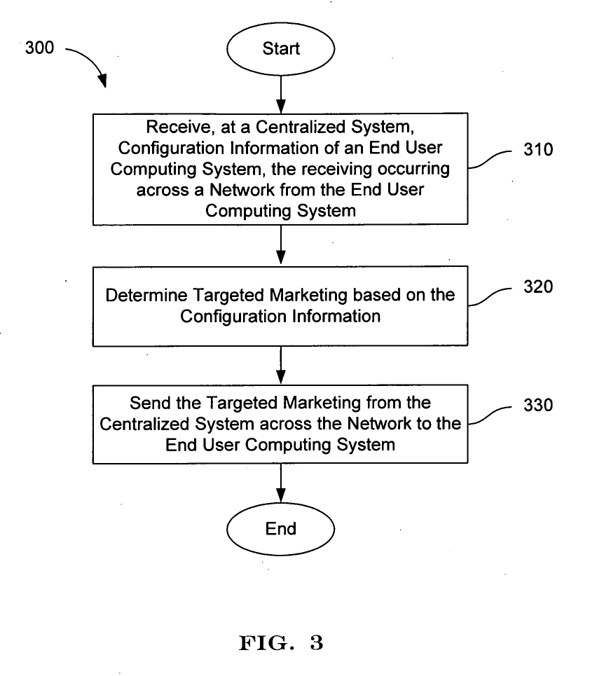

FIG. 3 illustrates another exemplary method 300 of the invention. While the method 200 (FIG. 2) can be performed, for example, by the end user computing system 110 (FIG. 1), the method 300 can be performed instead by the centralized system 120 (FIG. 1). The method 300 comprises receiving 310, at the centralized system, configuration information of an end user computing system, the receiving occurring across a network from the end user computing system. The method 300 also comprises determining 320 targeted marketing based on the configuration information, and sending 330 the targeted marketing from the centralized system across the network to the end user computing system.

The method 300 comprises receiving 310 configuration information at the centralized system. Here, the configuration information is of the end user computing system. Once the configuration information has been received, the centralized system can optionally store the configuration information in a database for later reference. In some of these embodiments, the database associates the configuration information with a unique ID for the end user computing system.

As noted, the method 300 comprises determining 320 targeted marketing based on the configuration information received from the end user computing system. A simple example has already been described where the configuration information specifies a particular printer and the targeted marketing is directed to toner cartridges for that printer. Determining 320 targeted marketing based on the configuration information can also comprise comparing hardware specific configuration information with software specific configuration information. For instance, where hardware specific configuration information indicates that a DVD burner is installed, but the software specific configuration information only indicates CD burning software, determining 320 targeted marketing can comprise selecting an advertisement for DVD recording software.

In some embodiments, the configuration information specifies a default language of the end user computing system. In these embodiments, determining 320 targeted marketing based on the configuration information can include selecting targeted marketing that is written in the default language. For example, where the default language is Spanish, determining targeted marketing can include selecting targeted marketing written in Spanish.

Other information besides configuration information can be considered when determining 320 targeted marketing. For example, advertisers can pay for priority consideration. Thus, where the configuration information specifies an installed printer, two advertisements may be pertinent—one from a producer of refilled toner cartridges, and one from the printer manufacturer. Here, if the printer manufacturer paid for priority consideration, then the advertisement for a new toner cartridge made by the printer manufacturer could be selected over the advertisement for refilled toner cartridges. The advertisement for refilled toner cartridges could potentially be sent 330 at a later time, for example.

As noted with respect to method 200, user settings and information derived from monitoring the end user computing system are examples of other information that can also be received by the centralized system for the purpose of determining 320 targeted marketing. Similarly, other information about the user can be obtained from a 3^{rd} party system 140 (FIG. 1) for the purpose of determining 320 targeted marketing. For example, the 3^{rd} party system can be an on-line retailer capable of providing to the centralized system information about previous on-line activities, such as purchases and visited websites, that are associated with the end user computing system. Thus, determining 320 targeted marketing can also consider any of this additional information.

The method 300 also comprises sending 330 the targeted marketing from the centralized system across the network to the end user computing system. The end user computing system can then display and/or store the targeted marketing. In some embodiments, the targeted marketing can be sent 330 in a format that is readable by an Internet browser so that the targeted marketing can be displayed in a window of the browser. In other embodiments, the targeted marketing can be sent within an e-mail, or as an attachment to an e-mail. Further, targeted marketing can be sent by methods that do not involve transmission over the network, such as by postal service or courier.

The present invention is also directed to devices that comprise a computer readable medium having stored thereon computing instructions for performing certain methods of the invention described above. Such devices can be connected to an end user computing system so that the end user computing system can be searched for configuration information, the configuration information can be sent to a centralized system, and so that the end user computing system can receive targeted marketing from the centralized system. While the device can be, for example, any of the attached peripherals discussed above, specific examples where the device is particularly a backup device are described below with respect to FIGS. 4, 5, and 7.

FIG. 4 shows a schematic representation of an exemplary backup device 400 connected to an end user computing system 110 by a connection 410, using technology as disclosed in U.S. patent application Ser. No. 11/506,386. The backup device 400 comprises a communication interface 420, an emulation component 430, and a computer readable medium 440 that includes a first logical storage area 450 and second logical storage area 460. The computer readable medium 440 can be, for example, a hard disk drive (HDD) that has been partitioned into at least two logical storage areas. Other suitable computer readable media 440 are solid-state memory devices, such as Secure Digital (SD) memory cards and CompactFlash (CF) memory cards. The computer readable medium 440 can also be implemented by two different devices, one dedicated to each of the two logical storage areas 450, 460. In some embodiments, the backup device 400 further comprises a memory device interface 470 that allows the first and second logical storage areas 450 and 460 to communicate with the emulation component 430.

The first logical storage area 450 represents a logical area of the computer readable medium 440 that is meant to be inaccessible to the user and safe from accidental erasure. The first logical storage area 450 can contain, for example, a backup application, a look-up table, system files, drivers, and other setup and configuration software. The first logical storage area 450 can also contain a separate application for automatically searching for configuration information, sending the same to a centralized system, and receiving targeted marketing as discussed above. The first logical storage area 450 is represented to the end user computing system 110 by the emulation component 430 as being an auto-launch device. As used herein, auto-launch devices are those devices that will trigger the automatic execution functionalities of certain operating systems, such as the AutoRun function of the Microsoft Windows operating system.

The second logical storage area 460 represents a logical area of the computer readable medium 440 that is dedicated to storing backed-up data files, for example. Accordingly, the emulation component 430 represents the second logical storage area 460 to the end user computing system 110 as being a writable computer readable medium. With reference to FIG. 1, where the new hardware 150 comprises the backup device 400, the backup application can be launched automatically when the backup device 400 is connected to the end user computing system 110. The backup application, or a separate application that can also be auto-launched, can then perform a method described herein to automatically search for configuration information from the end user computing system 110, send the same to a centralized system, and receive targeted marketing.

FIG. 5 shows a schematic representation of an exemplary backup device 500 using technology as disclosed in U.S. patent application Ser. No. 11/546,176. The backup device 500 comprises an optical disc having two portions, a read-only portion 510 and a writable portion 520. The portions 510, 520 can comprise either the same or different media formats. The read-only portion 510 includes computer-readable instructions for a backup application. The read-only portion 510 also includes computer-readable instructions, as part of the backup application or a separate application, for automatically searching the end user computing system 110 for configuration information, sending the same to a centralized system, and receiving targeted marketing.

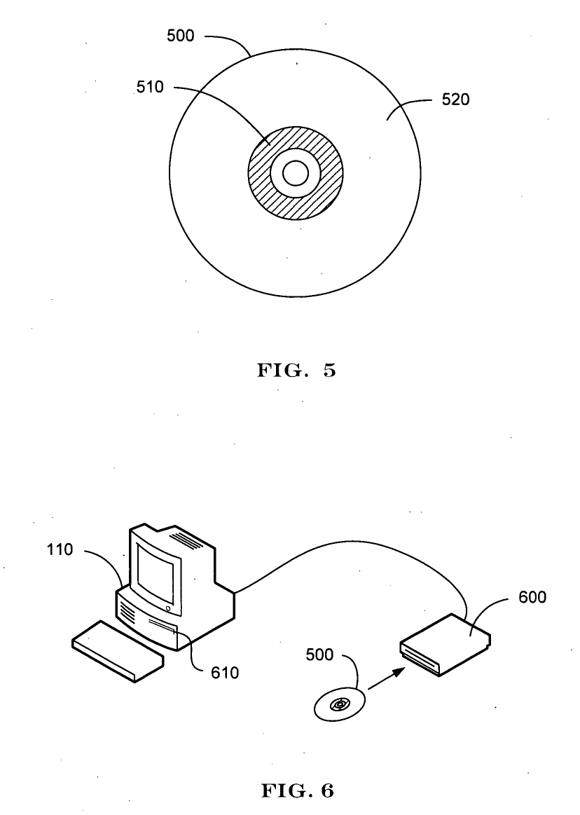

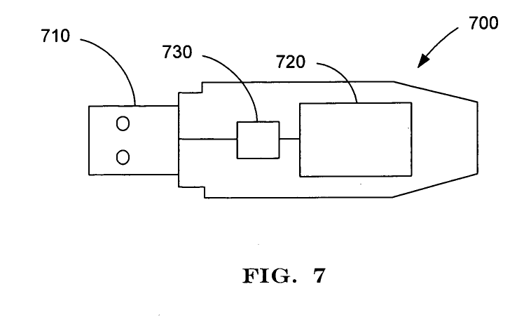

FIG. 6 shows an end user computing system 110 connected to an external optical drive 600 for reading from and writing to the backup device 500. The end user computing system 110 can alternatively or additionally include an internal optical drive 610 for the same purpose. When the backup device 500 is inserted into either of the optical drives 600, 610, the operating system of the end user computing system 110 can automatically launch the backup application or a separate application to then perform a method described herein to automatically search the end user computing system 110 for configuration information, send the same to a centralized system, and receive targeted marketing.

FIG. 7 shows a schematic representation of an exemplary backup device 700 using technology as disclosed in U.S. patent application Ser. No. 11/601,040. The backup device 700 comprises a USB interface 710. The backup device 700 can be, for example, a USB flash drive (UFD) such as a key drive, pen drive, jump drive, thumb drive, a memory stick, or the like. The backup device 700 also comprises a flash memory 720 and an emulation component 730 in communication between the flash memory 720 and the USB interface 710. The flash memory 720 includes computer-readable instructions comprising a backup application, or a separate application, that is configured to perform a method of the invention described herein to automatically search the end user computing system 110 for configuration information, send the same to a centralized system, and receive targeted marketing. When the backup device 700 is connected to a USB interface of the end user computing system 110, the operating system of the end user computing system 110 can recognize the backup device 700 as an auto-launch device, because of the emulation component 730, and automatically launch the backup application and/or the separate application.

It will be appreciated that the Windows Vista operating system allows devices to designate themselves as auto-launching. The emulation components 430, 730 in the backup devices 400 and 700 are therefore optional in those embodiments where these backup devices will be used with Windows Vista or some other operating system that provides similar functionality. In these embodiments, because the backup device can designate itself as auto-launching, the backup application can auto-launch.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A method comprising:
automatically searching an end user computing system for configuration information of the end user computing system;
sending the configuration information across a network to a centralized system; and
receiving targeted marketing from the centralized system across the network, the targeted marketing based on the configuration information.

2. The method of claim 1 wherein automatically searching the end user computing system includes searching operating system files.

3. The method of claim 1 wherein automatically searching the end user computing system includes searching an initialization file.

4. The method of claim 1 wherein automatically searching the end user computing system is performed in response to a trigger.

5. The method of claim 1 wherein sending the configuration information is performed in response to a trigger.

6. The method of claim 1 wherein the targeted marketing comprises an offer of goods or services.

7. The method of claim 1 further comprising noting that the configuration information has been sent.

8. The method of claim 1 further comprising receiving user consent to receive the targeted marketing.

9. The method of claim 1 further comprising displaying the targeted marketing on the end user computing system.

10. The method of claim 1 further comprising:
searching the end user computing system for a user setting;
sending the user setting across the network to the centralized system; and
receiving targeted marketing from the centralized system across the network, the targeted marketing based on the user setting.

11. The method of claim 1 further comprising monitoring the end user computing system.

12. The method of claim 1 further comprising storing the received targeted marketing on the end user computing system.

13. A method comprising:
receiving, at a centralized system, configuration information of an end user computing system, the receiving occurring across a network from the end user computing system;
determining targeted marketing based on the configuration information; and
sending the targeted marketing from the centralized system across the network to the end user computing system.

14. The method of claim 13 wherein the configuration information specifies a default language and wherein determining targeted marketing based on the configuration information includes selecting targeted marketing written in the default language.

15. The method of claim 13 wherein determining targeted marketing includes considering information about previous on-line activities associated with the end user computing system.

16. The method of claim 13 wherein sending the targeted marketing includes sending an e-mail.

17. The method of claim 13 wherein the targeted marketing comprises an offer of goods or services.

18. The method of claim 13 further comprising storing the configuration information in a database.

19. The method of claim 18 wherein the database associates the configuration information with a unique ID for the end user computing system.

20. The method of claim 13 wherein determining the targeted marketing is further based on priority consideration.

21. A computer readable medium having stored thereupon computing instructions comprising:
a code segment to automatically search an end user computing system for configuration information of the end user computing system;
a code segment to send the configuration information across a network to a centralized system; and
a code segment to receive targeted marketing from the centralized system across the network, the targeted marketing based on the configuration information.

22. The computer readable medium of claim 21 further comprising a code segment to receive user consent to receive the targeted marketing.

23. The computer readable medium of claim 21 further comprising a code segment to display the targeted marketing on the end user computing system.

24. The computer readable medium of claim 21 further comprising
a code segment to search the end user computing system for a user setting;
a code segment to send the user setting across the network to the centralized system; and
a code segment to receive targeted marketing from the centralized system across the network, the targeted marketing based on the user setting.
